(19) United States
(12) Patent Application Publication
(10) Pub. No.: US 2014/0082304 A1
(43) Pub. Date: Mar. 20, 2014

(54) MONITORING A SUBSEA INSTALLATION

(71) Applicant: Andrew Malcolm George Clarke, Nailsea (GB)

(72) Inventor: Andrew Malcolm George Clarke, Nailsea (GB)

(21) Appl. No.: 13/990,060

(22) PCT Filed: Nov. 24, 2011
(86) PCT No.: PCT/GB11/52309

§ 371 Date: May 29, 2013

(30) Foreign Application Priority Data
Nov. 29, 2010 (EP) 10193016.2

(51) Int. Cl. E21B 47/00; G06F 3/00

(52) U.S. Cl. CPC E21B 47/0001; G06F 3/00
USPC 711/154; 166/336

(57) ABSTRACT

There is disclosed a method of monitoring a subsea installation comprising: providing data storage means in a subsea control module and storing data resulting from the monitoring of equipment of the installation in the storage means.

### FIELD OF THE INVENTION

The present invention relates to monitoring a subsea installation, such as a hydrocarbon extraction well installation.

### BACKGROUND OF THE INVENTION

FIG. 1 shows the typical system configuration of a subsea hydrocarbon extraction well installation. The configuration comprises the following.

A topside master control unit (MCU) 1, an electrical power unit 2 and a hydraulic power unit 3, all of which may be installed on a rig, floating platform or onshore. The MCU 1 provides an operator interface with items of subsea equipment, and displays the current states of such equipment and sensor information, enabling the operator to control the system. It also enables trend analysis to be carried out and historical reports to be generated. The MCU 1 collates data such as the operational states of subsea valves and data relating to the state of production flow into and across an entire hydrocarbon extraction field for example. Electrical and hydraulic power is provided for the items of subsea equipment by units 2 and 3.

An umbilical cable 4 which connects the above units to items of equipment installed on the sea bed (and usually mounted on a Christmas tree 6), the umbilical 4 carrying communication links.

A subsea control module (SCM) 5 installed on the Christmas tree 6, the SCM 5 controlling subsea control processes, providing hydraulic power on a line 7 to actuate valves mounted on the Christmas tree 6 and at the wellhead. It also receives process instrumentation signals on a line 8 from sensors mounted on the Christmas tree and at the wellhead, the signals being received and processed in a subsea electronics module (SEM) 9 in the SCM 5.

The subsea equipment has to be reliable and operate in the harsh environment subsurface and ensure satisfactory operation over a life of up to 25 years, for example. Knowledge of the states of items of equipment is required in order to achieve satisfactory performance and to reconfigure or replace equipment where performance is deteriorating, before major faults occur which require the system to be shut down. For this purpose, instrumentation is built into the subsea equipment to monitor the operational states of pieces of equipment, in the form of a health or condition monitoring circuitry 10 on a circuit board or card in the SEM 9. Although a typical SEM monitors many parameters, it does not record them—data such as board temperatures, board resets, power up times is not currently recorded, there is no chronological context and such data is not available topside.

Typically, although the state of the DCVs is sent back topside (the MCU invoking commands and the SCM responding to say it has actioned them) and pressure profile data is also presented topside which confirms the operation, information about the health and environment of the SEM and/or the SCM is not available topside. Also, although such information is analysed and stored topside in a customer database alongside commercially sensitive customer information, it is not easily extracted or made available by the customer to the SCM supplier and/or maintainer.

### SUMMARY OF THE INVENTION

According to the present invention from one aspect, there is provided a method of monitoring a subsea installation, comprising:
providing data storage means in a subsea control module; and
storing data from the monitoring of equipment of the installation in the storage means.

According to the present invention from another aspect, there is provided a subsea well installation comprising a subsea control module in which is provided data storage means, the data storage means being adapted for storing data resulting from monitoring equipment of the installation.

Preferably, said data storage means is in a subsea electronics module of the subsea control module. In this case, the data storage means could be on a circuit board of the subsea electronics module which carries condition monitoring circuitry.

The data storage means preferably comprises a non-volatile memory.

The data storage means could be pre-configured with information identifying equipment being monitored.

The data could include results from the monitoring of equipment of the subsea control module and/or conditions in the subsea control module. Such data could include results from monitoring at least one of a directional control valve of the subsea control module, temperatures and pressures, commands to operate DCVs, fluid levels, humidity, salinity, board power up times and board power (particularly relevant for optical modems).

The data could include results from the monitoring of equipment on a Christmas tree of the installation and/or sensors of the installation.

Preferably, data is stored in said storage means in the form of a chronological log.

An embodiment of the invention includes the provision of built-in data storage means in the subsea electronics module of a subsea control module of a subsea hydrocarbon well installation, which data storage means is capable of storing relevant operational states and condition or health monitoring data relating to the subsea control module and Christmas tree mounted equipment. This enables the subsea control module to maintain its own historical log that is independent of the sensitive data held in the customer's master control unit database and is available whenever repairs have to be carried out by the manufacturer.

The invention enables the provision of a “black box” function for subsea control equipment. Although the invention finds particular utility in the case of hydraulically activated subsea control, it is equally applicable to an all-electric subsea control system and could be applied elsewhere than in a well installation, for example to a CO₂ sequestration installation.

### BRIEF DESCRIPTION OF THE DRAWINGS

FIG. 1 is a schematic diagram of the typical configuration of a subsea hydrocarbon extraction well installation; and

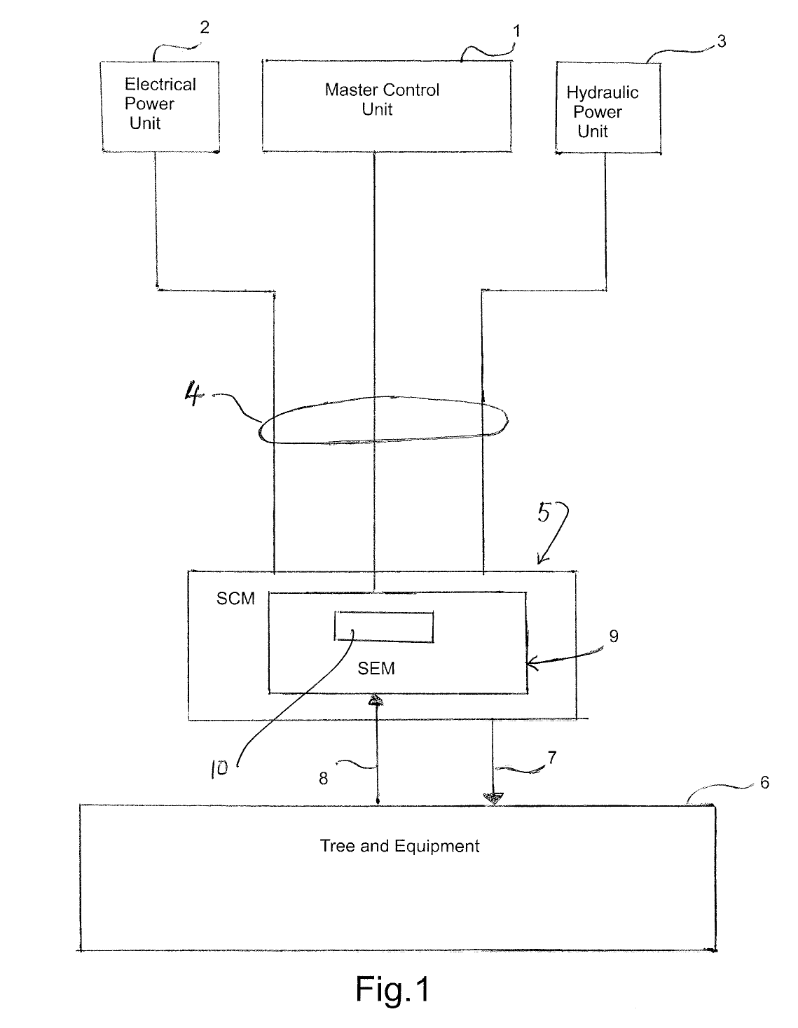

FIG. 2 is a schematic diagram of the configuration of FIG. 1 modified in accordance with an embodiment of the invention.

### DETAILED DESCRIPTION OF THE INVENTION

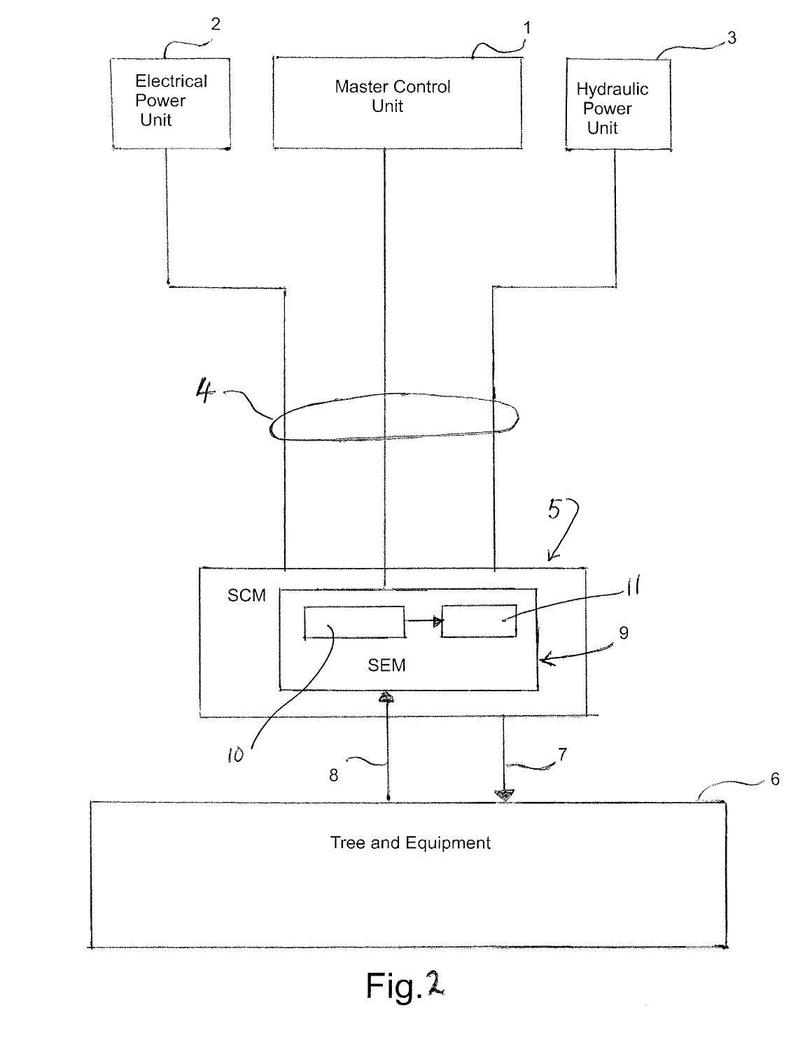

Referring to FIG. 2 and as stated above, the SCM 5 includes subsea electronics module 9. The module 9 is microprocessor based and comprises several printed circuit boards or cards, with various functions such as communication with the MCU 1, interfacing with instrumentation and sensors and controlling valves and hydraulics. It also contains health or condition monitoring circuitry 10 on a circuit board or card, and in the embodiment of the present invention, a non-volatile memory 11 is included on the card as data storage means in communication with circuitry 10. The memory 11 provides a database which can be pre-configured with basic information identifying the serial numbers of the components of the SCM 5, such as printed circuit boards or cards and directional control valves (DCVs) and each component on the Christmas tree 6 and/or a manifold. These can be kept in separately partitioned parts of the database. The historical records in the storage means comprising data from the monitoring of equipment of the installation will include the status of various items of equipment throughout their operational life (such as each DCV).

Instead of receiving data from circuitry 10, the memory 11 could receive data for storage from software running on the SCM 5, such as “house-keeping” software.

In a basic embodiment, the data storage means 11 will receive data concerning the components and processes in the SCM 5 itself (such as data which includes results from monitoring at least one of a directional control valve of the SCM control module, temperatures and pressures, commands to operate DCVs, fluid levels, humidity, salinity, board power up times and board power (particularly relevant for optical modems) but it will be appreciated that the present invention may be used in respect of all of the items of subsea equipment with which the SCM 5 interfaces.

The data in the storage means 11 could be protected so that it cannot be tampered with.

To create a chronological log of data stored in memory 11, the SEM 5 must have a concept of absolute time. Currently, SEMs do not have this. Accordingly, the embodiment is preferably provided with time synchronisation by a remote server, which could be accommodated by embedding a time stamp in control commands received from the MCU 1 or by the SEM running a process that actively solicits a time stamp when it needs one. The MCU 1 or any other remote server could host a client to service this (e.g. using Network Time Protocol). Typically, entering data into the memory 11 only occurs when the value of a parameter changes or when a particular event occurs.

### ADVANTAGES OF USING THE INVENTION

The invention can automate and make readily available the collection of basic data on the cycles accumulated by items of subsea equipment associated with the control of Christmas tree infrastructure down to the level of actuators and valves.

By being included within the SCM itself, the database provided by the data storage means is physically decoupled from sensitive customer data within the MCU.

Health or condition monitoring has no control functionality and, as such, a customer can be assured that receiving data from it will be non-intrusive.

Data can be used by the well equipment supplier to assist diagnostic efforts, to facilitate collection of actuator usage measurements for example and therefore to produce more informed arguments and information for qualification criteria.

Information provided by the data storage means can also be shared with customers as part of their asset management programmes.

The invention can provide the critical input to populating “on-line” probabilistic reliability models—i.e. the data in the storage means could provide all the life usage data for a subsea well installation.

The storage means can provide an unambiguous record of how a subsea well installation had been operated. This could be particularly important following an incident where perhaps a floating platform, and the operational data carried in the MCU, was lost.

What is claimed is:

1-14. (canceled)

15. A method of monitoring a subsea well installation comprising:
providing data storage means in a subsea control module of the installation; and
storing data resulting from the monitoring of equipment of the installation in the storage means.

16. A method according to claim 15, wherein said data storage means is in a subsea electronics module of the subsea control module.

17. A method according to claim 16, wherein said data storage means is on a circuit board which carries condition monitoring circuitry.

18. A method according to claim 15, wherein said data storage means comprises a non-volatile memory.

19. A method according to claim 15, wherein said data storage means is pre-configured with information identifying equipment being monitored.

20. A method according to claim 15, wherein said data results from the monitoring of at least one of: equipment on a Christmas tree of the installation; sensors of the installation; and equipment of the subsea control module.

21. A method according to claim 20, wherein said equipment of the subsea control module comprises at least one directional control valve.

22. A method of monitoring a subsea well installation comprising:
providing data storage means in a subsea control module of the installation; and
storing data resulting from the monitoring of equipment of the installation in the storage means, wherein:
said data storage means is in a subsea electronics module of the subsea control module and comprises a non-volatile memory; and
said data results from the monitoring of at least one of: equipment on a Christmas tree of the installation; sensors of the installation; and equipment of the subsea control module.

23. A method according to claim 22, wherein said data storage means is on a circuit board which carries condition monitoring circuitry.

24. A method according to claim 22, wherein said data storage means is pre-configured with information identifying equipment being monitored.

25. A method according to claim 22, wherein said equipment of the subsea control module comprises at least one directional control valve.

26. A subsea well installation comprising a subsea control module in which is provided data storage means, the data storage means being adapted for storing data resulting from the monitoring of equipment of the installation.

27. An installation according to claim 26, wherein said data storage means is in a subsea electronics module of the subsea control module.

28. An installation according to claim 27, wherein said data storage means is on a circuit board which carries condition monitoring circuitry.

29. An installation according to claim 26, wherein said data storage means comprises a non-volatile memory.

30. An installation according to claim 26, wherein said data storage means is pre-configured with information identifying equipment being monitored.

31. An installation according to claim 26, wherein said data results from the monitoring of at least one of: equipment on a Christmas tree of the installation; sensors of the installation; and equipment of the subsea control module.

32. An installation according to claim 31, wherein said equipment of the subsea control module comprises at least one directional control valve.

33. An installation according to claim 26, wherein said data storage means is in a subsea electronics module of the subsea control module and comprises a non-volatile memory and said data results from the monitoring of at least one of: equipment on a Christmas tree of the installation; sensors of the installation; and equipment of the subsea control module.

34. An installation according to claim 33, wherein said equipment of the subsea control module comprises at least one directional control valve.
